(19) United States
(12) Patent Application Publication
(10) Pub. No.: US 2025/0270408 A1
(43) Pub. Date: Aug. 28, 2025

(54) SILICA DISPERSION COMPRISING A POLYALKYLENEAMINE POLYESTER BASED DISPERSANT

(71) Applicant: BASF SE, Ludwigshafen am Rhein (DE)

(72) Inventors: Huiguang KOU, Ludwigshafen am Rhein (DE); Steffen ONCLIN, Ludwigshafen am Rhein (DE); Johannes Hermann WILLENBACHER, Ludwigshafen am Rhein (DE); Jessica WEISEL, Ludwigshafen am Rhein (DE); Clemens AUSCHRA, Ludwigshafen am Rhein (DE)

(21) Appl. No.: 18/704,964

(22) PCT Filed: Oct. 28, 2022
(86) PCT No.: PCT/EP2022/080225

§ 371 Date: Apr. 26, 2024

(30) Foreign Application Priority Data
Oct. 29, 2021 (EP) 21205547.9

(51) Int. Cl. C09D 5/02; C01B 33/141; C08K 3/36; C09D 7/61

(52) U.S. Cl. CPC C09D 5/027; C01B 33/141; C08K 3/36; C09D 7/61

(57) ABSTRACT

The presently claimed invention relates to silica dispersion comprising a dispersant and a method for preparation thereof. The presently claimed invention is also directed to a coating composition comprising the silica dispersion. The dispersant comprises a polyalkyleneamine as a polymer backbone and at least one polyoxyalkylenecarbonyl attached to the polymer backbone.

### FIELD OF THE INVENTION

The presently claimed invention is directed to silica dispersion comprising a dispersant and a method for preparation thereof. The presently claimed invention is also directed to a coating composition comprising the silica dispersion.

### BACKGROUND OF THE INVENTION

Silica is commonly used in the coatings industry as a cost-efficient filler, matting agent and for rheological control. Silica dispersions are used in a wide range of applications such as coating compositions and enhancing mechanical properties of a coating film.

Important properties of an effective silica dispersion are easy dispersibility, ability to disperse and stabilize high amount of silica, suspension stability, effective reduction of viscosity of silica dispersion and the coating formulation, compatibility with a variety of coating systems, high matting power, and Newtonian flow behavior for ease of application on substrate.

It is known that a silica dispersion requires an additive to stabilize the dispersion by preventing the sedimentation and agglomeration of silica particles. Generally, the additive is a dispersant. Examples of dispersants that are suitable for silica dispersion are known in prior art.

US2021198513 discloses a particulate inorganic oxide dispersion comprising a dispersant selected from the group consisting of polyacrylic acid dispersants, polycarboxylic acid dispersants, phosphoric acid dispersants, and silicone dispersants.

JP2021075588 discloses use of a polyamine dispersant to form dispersion of inorganic particles in water in low pH of 1 to 6.

JP2021066798 discloses an inorganic particles dispersion comprising a polyether dispersant.

However, it is difficult to obtain a stable dispersion comprising silica, and additional solids such as resins. Stability is generally achieved by preventing coalescence of the particles by means of ionic or steric repulsion between particles as a result of the adsorption of a dispersant on the particle surface. For example, in paint and coating formulations, properties like stability during storage, application properties of liquid paint, stability during exposure, gloss level, opacity and color development etc. are largely related to the dispersion stability. Further, the use of a dispersant to stabilize a silica dispersion can lead to other problems such as an increase in the viscosity of the silica dispersion, and lack of Newtonian flow behavior.

Furthermore, a coating composition comprising the silica dispersion tend to have a poor matting effect and a high gloss.

Therefore, there is still an ongoing need to obtain silica dispersions comprising dispersants that can provide silica dispersions having good dispersion behaviour such as low viscosity and high stability, good coating properties, good matting effect, and low gloss.

Accordingly, it is an object of the presently claimed invention to provide a silica dispersion having a high stability and a low viscosity. Further, it is an object of the presently claimed invention to provide a silica dispersion displaying Newtonian behavior and easy dispersibility. It is also an objective of the presently claimed invention to provide a coating composition that on application results in a coating having a good matting effect and a low gloss.

### SUMMARY OF THE INVENTION

It was surprisingly found that the presently claimed invention provides a silica dispersion that overcomes one or more of the above-mentioned drawbacks. Particularly, the presently claimed invention provides a silica dispersion having a good stability and a low viscosity. The silica dispersion exhibits a good Newtonian behavior, and its application results in a coating with a good matting effect, and a low gloss.

Accordingly, an aspect of the presently claimed invention is directed to a silica dispersion comprising
at least one silica,
at least one resin, and
at least one dispersant D comprising
   a polyalkyleneamine P as a polymer backbone; and
   at least one polyoxyalkylenecarbonyl of formula (I) attached to the polyalkyleneamine P by a C—N bond involving a nitrogen of the polyalkyleneamine P and a carbonyl of A,

#-(A)ₘ-T (I)
wherein, #indicates the point of attachment of (I) to a nitrogen atom of the polyalkyleneimine P;
A is an oxyalkylenecarbonyl unit of formula —C(═O)—R¹—O—; and the polyoxyalkylenecarbonyl (A)ₘ comprises identical or different oxyalkylenecarbonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.

Another aspect of the presently claimed invention is directed to a coating composition comprising the silica dispersion.

Yet another aspect of the presently claimed invention is directed to use of the silica dispersion as a coating agent.

### DETAILED DESCRIPTION OF THE INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out sim-ultaneously or there may be time intervals of seconds, minutes, hours, days, weeks, months or even years between such steps, unless otherwise indicated in the application as set forth herein above or below.

Furthermore, the ranges defined throughout the specification include the end values as well i.e., a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure, or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to so.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

The silica dispersion of the presently claimed invention comprises a dispersant that has appropriate amine number, and a low molecular weight. The backbone of the dispersant is a polyamine chain that can act as an anchoring group for the surface of silica particles, and the polyester chains attached on the backbone can act as a stabilizer and improve the compatibility of the dispersant with broad range of resins. As a result, the silica dispersions of the presently claimed invention are stable and highly efficient.

The presently claimed invention provides a silica dispersion having a low viscosity. The silica dispersion of the presently claimed invention has easy dispersibility and its application results in coatings having a good matting effect and a low gloss.

Accordingly, an aspect of the presently claimed invention is directed to a silica dispersion comprising
at least one silica,
at least one resin, and
at least one dispersant D comprising
   a polyalkyleneamine P as a polymer backbone; and
   at least one polyoxyalkylenecarbonyl of formula (I) attached to the polyalkyleneamine P by a C—N bond involving a nitrogen of the polyalkyleneamine P and a carbonyl of A,

#-(A)ₘ-T (I)
wherein,
#indicates the point of attachment of (I) to a nitrogen atom of the polyalkyleneimine P;
   A is an oxyalkylenecarbonyl unit of formula —C(═O)—R¹—O—; and the polyoxyalkylenecarbonyl (A)ₘ comprises identical or different oxyalkylenecarbonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.

In a preferred embodiment, the dispersant D is represented as

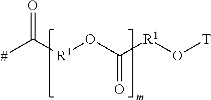

wherein, #is indicates the point of attachment to a nitrogen atom of the polyalkyleneimine backbone, R¹, m and T are as defined above. [R¹OC(O)]ₘ comprises identical or different, substituted or unsubstituted, linear or branched C₃-C₈ alkylene groups.

In a preferred embodiment, the silica dispersion comprises
at least one silica,
at least one resin, and
at least one dispersant D obtainable by step (i), (ii), (iii), or (iv);
(i) a process comprising reacting at least one polyalkyleneamine P with at least one polyester (II) selected from II-A, II-B, and II-C,

HO-[A]ₘ—H (II-A),

HO-[A]ₘ—C(═O)R₂ (II-B), or

HO-[A]ₘ—C(═O)—R³—OH (II-C),
wherein, [A]ₘ, R₂ and R₃ are as defined above;
(ii) a process comprising reacting at least one polyalkyleneamine P with at least one lactone of formula (III)

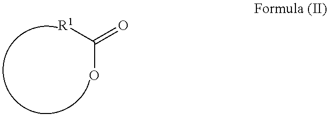

(iii) a process comprising reacting at least one polyalkyleneamine P with a mixture comprising at least one lactone of formula (III) and at least one acid
   HO—C(═O)R², wherein R² is as defined above; and
(iv) a process comprising reacting at least one polyalkyleamine P with a mixture comprising at least one lactone of formula (III) and at least one hydroxyacid
   HO—C(═O)—R³—OH, wherein R³ is as defined above.

In a preferred embodiment, the polyalkyleneamine P is at least one selected from the group consisting of polyethyleneimine, and polypropylenamine.

In a preferred embodiment, polyalkyleneamine P is polyethyleneimine.

In a preferred embodiment, polyalkyleneamine P has a molecular weight in the range from 300 to 10000 g/mol, more preferably 400 to 8000 g/mol, even more preferably 400 to 6000 g/mol, and even more preferably 500 to 4000 g/mol determined to according to DIN 55672-1.

In a most preferred embodiment, polyalkyleneamine P has a molecular weight in the range from 500 to 2500 g/mol determined to according to DIN 55672-1.

In a particularly preferred embodiment, polyalkyleneamine P has a molecular weight 800 g/mol determined to according to DIN 55672-1.

In a particularly preferred embodiment, polyalkyleneamine P has a molecular weight 2000 g/mol determined to according to DIN 55672-1.

### Polyethylenimine (PEI)

Polyethylenimine (PEI) can be commercially prepared by acid-catalyzed ring opening of ethyleneimine, also known as aziridine. (The latter, ethyleneimine, is prepared through the sul-furic acid esterification of ethanolamine). Polyethyleneimines can have an average molecular weight of 100 to 5,000,000 or even higher. The amine groups of PEI exist mainly as a mixture of primary, secondary and tertiary groups. PEIs can be linear or branched polymers.

In a preferred embodiment, polyethyleneimines are branched.

In a preferred embodiment, the polyethyleneimine has a molecular weight in the range from 300 to 10000 g/mol, more preferably 400 to 8000 g/mol, even more preferably 400 to 6000 g/mol, and even more preferably 500 to 4000 g/mol determined to according to DIN 55672-1.

In a most preferred embodiment, polyethyleneimine has a molecular weight in the range from 500 to 2500 g/mol determined to according to DIN 55672-1.

In a particularly preferred embodiment, polyethyleneimine has a molecular weight 800 g/mol determined to according to DIN 55672-1.

In a particularly preferred embodiment, polyethyleneimine has a molecular weight 2000 g/mol determined to according to DIN 55672-1.

PEIs are commercially available from the BASF Corporation under the trade name Lupasol® (also sold as Polymin®). These compounds can be prepared with a wide range of molecular weights and product activities. Examples of commercial PEIs sold by BASF include, but are not limited to, Lupasol FG®, Lupasol G-35®), Lupasol-PR, Lupasol-PS®, Lupasol-(Water-Free)® and the like.

In a preferred embodiment, R¹ is at least one selected from —(CH₂)₅—, —(CH₂)₄—, —(CH₂)₃—, and combinations thereof.

In a more preferred embodiment, R¹ is at least one selected from —(CH₂)₅—, —(CH₂)₄—, and combinations thereof.

In a particularly preferred embodiment, R¹ is (CH₂)₅—.

In a particularly preferred embodiment, R¹ is —(CH₂)₄—.

In a particularly preferred embodiment, (A)ₘ IS

(A¹)_{M1}(A²)_{M2},

wherein A¹ and A² are different from each other and each is selected from the group consisting of —O—(CH₂)₅—C(═O)—, —O—(CH₂)₄—C(═O)— and —O—(CH₂)₃—C(═O)—; and
M1 and M2 are, identical or different, in the range from 1 to 40, and the ratio of M1 and M2 is in the range from 10:1 to 1:10.

In a more preferred embodiment, (A)ₘ is

—(—O—(CH₂)₅—C(═O)—)_{M1}(—O—(CH₂)₄—C(═O)—)_{M2}—,

wherein M1 and M2 are, identical or different, in the range from 1 to 40, and the ratio of M1 and M2 is in the range from 10:1 to 1:10.

In a particularly preferred embodiment, the dispersant D is represented as

P—((A¹)_{M1}(A²)_{M2})-T

In a preferred embodiment, the dispersant D is (D-I).

P-(A)ₘ—H (D-I)

In a preferred embodiment, the dispersant D is (D-II).

P-(A)ₘ—C(═O)R² (D-II)

wherein R² is a substituted or unsubstituted, linear or branched C₁₀-C₁₈ alkyl.

In a more preferred embodiment, R² is selected from C₁₁H₂₃, C₁₃H₂₇, C₁₅H₃₁, and C₁₇H₃₅.

In a particularly preferred embodiment, R² is C₁₁H₂₃.

In a preferred embodiment, the dispersant D is (D-III).

P-(A)ₘ—C(═O)—R³—OH (D-III)

wherein R³ is a substituted or unsubstituted, linear or branched C₈-C₂₀ alkylene.

In a more preferred embodiment, R³ is selected from C₁₇H₃₄, 9,10-dihydroxyoctadecyl, 2, 15, 16-trihydroxypalmityl, and 2, 15, 16-trihydroxyhexadecyl.

In a particularly preferred embodiment, R³ is C₁₇H₃₄.

In a preferred embodiment, the molecular weight of the dispersant D is in the range of 2,000 g/mol to 100,000 g/mol determined according to DIN 55672-1.

In a more preferred embodiment, the molecular weight of the dispersant D is in the range of 2,000 g/mol to 50,000 g/mol, even more preferably 2,000 g/mol to 30,000 g/mol, even more preferably 3,000 g/mol to 20,000 g/mol, and most preferably 4,000 g/mol to 15,000 g/mol determined according to DIN 55672-1.

In a preferred embodiment, the polydispersity index (PDI) of the dispersant D is in the range of 1.5 to 3.0, and most preferably 2.0 to 3.0.

In a preferred embodiment, the amine number of the dispersant D is in the range of 5 mg KOH/g to 200 mg KOH/g, and more preferably 10 mg KOH/g to 100 mg KOH/g according to DIN 53176:2002-11.

In a preferred embodiment, the acid number of the dispersant D is in the range of 1 mg KOH/g to 50 mg KOH/g according to DIN 53402:1990-09.

In a more preferred embodiment, the acid number of the dispersant D is in the range of 1 mg KOH/g to 20 mg KOH/g according to DIN 53402:1990-09.

In a preferred embodiment, weight of the dispersant D is in the range of 0.1 to 10 wt. % based on the total weight of the silica dispersion.

In a more preferred embodiment, weight of the dispersant D is in the range of 0.2 to 5.0 wt. %, and most preferably 0.5 to 3.0 wt. % based on the total weight of the silica dispersion.

In a particularly preferred embodiment, weight of the dispersant D is 1.0 wt. % based on the total weight of the silica dispersion.

The silica dispersion of the presently claimed invention exhibits desired properties such as a low viscosity, a high dispersibility and good matting effect using a low amount of the dispersant.

In a preferred embodiment, weight of the silica is in the range of 1 to 30 wt. % based on total weight of the silica dispersion.

In a more preferred embodiment, weight of the silica is in the range of 3 to 25 wt. %, even more preferably 5 to 20 wt. %, and most preferably 10 to 20 wt. % based on total weight of the silica dispersion.

In a preferred embodiment, particle size (d₅₀) of the silica is in the range of 1 μm to 30 μm, more preferably 2 μm to 20 μm, and even more preferably 3 μm to 10 um according to DIN 66133.

In a preferred embodiment, particle size (d₅₀) of the silica is 7.6 to 9.2 um according to DIN 66133.

In a preferred embodiment, the silica is selected from the group consisting of amorphous silica and crystalline silica.

In a more preferred embodiment, the silica is amorphous silica.

In a preferred embodiment, the silica is organically treated silica.

In a more preferred embodiment, the silica is organically treated with wax.

In a preferred embodiment, the resin is at least one selected from the group consisting of polyurethane resin, polyether resin, epoxy resin, and polyester resin.

In a preferred embodiment, the resin is a polyester resin.

The silica dispersion of the presently claimed invention is compatible with a wide range of resins.

In a preferred embodiment, weight of the resin is in the range of 30 to 98 wt. % based on total weight of the silica dispersion.

In a more preferred embodiment, weight of the resin is in the range of 30 to 80 wt. %, and most preferably 30 to 60 wt. % based on total weight of the silica dispersion.

In a particularly preferred embodiment, weight of the resin is 50 wt. % based on total weight of the silica dispersion.

In a preferred embodiment, the silica dispersion of the presently claimed invention further comprises at least one diluent.

In a preferred embodiment, the diluent is a UV curable or radiation curable reactive diluent.

In a preferred embodiment, the diluent is selected from the group consisting of dipropylene glycol di(meth)acrylate, 1,6-hexanediol di(meth)acrylate, trimethylolpropane tri(meth)acry-late, trimethylolpropane ethoxy tri(meth)acrylate, 2-phenoxyethyl (meth)acrylate, and glyceryl tetrapropylene tri(meth)acrylate.

In a preferred embodiment, weight of the diluent is in the range of 0.1 to 50 wt. % based on total weight of the silica dispersion.

In a more preferred embodiment, weight of the diluent is in the range of 5 to 50 wt. %, and most preferably 10 to 30 wt. % based on total weight of the silica dispersion.

In a preferred embodiment, the silica dispersion of the presently claimed invention further comprises at least one photoinitiator.

In a particularly preferred embodiment, the photoinitiator is 2-hydroxy-2-methylpropiophe-none.

In a preferred embodiment, the weight of the photoinitiator is in the range of 0.1 to 10 wt. %; and more preferably 2 wt. % to 6 wt. % based on the total weight of the silica dispersion.

The silica dispersion of the presently claimed invention further comprises at least one additive selected from wetting agent, defoaming agent, and levelling agent.

In a preferred embodiment, the silica dispersion of the presently claimed invention has a dis-persion viscosity in the range of 2500 to 10000 mPa·s, and most preferably 2500 to 6000 mPa·s.

In a preferred embodiment, the silica dispersion of the presently claimed invention has a Gloss 60° value in the range of 1 to 30, and most preferably in the range of 2 to 20.

Another aspect of the presently claimed invention is directed to a method for preparing the silica dispersion of the presently claimed invention. The method comprises the following steps:
a. preparing at least one dispersant D by step (i), (ii), (iii), or (iv);
   i. a process comprising reacting at least one polyalkyleneamine P with at least one polyester (II) selected from II-A, II-B, and II-C,

HO-[A]ₘ—H (II-A),

HO-[A]ₘ—C(═O)R₂ (II-B),

HO-[A]ₘ—C(═O)—R³—OH (II-C),
wherein R² and R³ are as defined above;
ii. a process comprising reacting at least one polyalkyleneamine P with at least one lactone of formula (III)

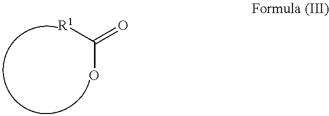

iii. a process comprising reacting at least one polyalkyleneamine P with a mixture comprising at least one lactone of formula (III) and at least one acid HO—C(═O)R²,
   wherein R² is as defined above; and
iv. a process comprising reacting at least one polyalkyleamine P with a mixture comprising at least one lactone of formula (III) and at least one hydroxyacid HO—C(═O)—R³—OH,
   wherein R³ is as defined above; and
b. mixing the dispersant D with at least one silica and at least one resin to obtain a ho-mogeneous mixture.

In a preferred embodiment, in step (i) the weight ratio of polyalkyleneamine P and the poly-ester (II) is in the range from 1:1 to 1:50, more preferably 1:1 to 1:30, even more preferably 1:2 to 1:25, and most preferably 1:3 to 1:25.

In a preferred embodiment, in step (i) the reaction of the polyalkyleneamine P and the poly-ester (II) is carried out at 100 to 230° C., more preferably 120 to 200° C., and most preferably at 150 to 200° C.

In a particularly preferred embodiment, in step (i) the reaction of the polyalkyleneamine P and the polyester (II) is carried out at 170° C.

In a preferred embodiment, the polyester (II-A) is prepared by polymerization of at least one lactone of formula (III).

In a preferred embodiment, polymerization of at least one lactone of formula (III) is carried out at 60 to 200° C., more preferably 80 to 200° C., more preferably 110 to 200° C., and most preferably at 140 to 200° C.

In a preferred embodiment, the polymerization of at least one lactone of formula (III) is carried out in the presence of a catalyst.

In a preferred embodiment, the polyester (II-B) is prepared by reaction of at least one lactone of formula (III) and at least one acid HO—C(═O)R², wherein R² is as defined above.

In a preferred embodiment, the reaction of at least one lactone of formula (III) and at least one acid HO—C(═O)R² is carried out at 60 to 200° C., more preferably 80 to 200° C., more preferably 110 to 200° C., and most preferably at 140 to 200° C.

In a preferred embodiment, the reaction of at least one lactone of formula (III) and at least one acid HO—C(═O)R² is carried out in the presence of a catalyst. In a preferred embodiment, the polyester (II-C) is prepared by reaction of at least one lactone of formula (III) and at least one hydroxyacid HO—C(═O)—R³—OH, wherein R³ is as defined above.

In a preferred embodiment, the reaction of at least one lactone of formula (III) and at least one hydroxyacid HO—C(═O)—R³—OH is carried out at 60 to 200° C., more preferably 80 to 200° C., more preferably 110 to 200° C., and most preferably at 140 to 200° C.

In a preferred embodiment, the reaction of at least one lactone of formula (III) and at least one hydroxyacid HO—C(═O)—R³—OH is carried out in the presence of a catalyst.

In a preferred embodiment, in step (ii) the weight ratio of polyalkyleneamine P and the lactone of formula (III) is in the range from 1:1 to 1:50, more preferably 1:1 to 1:30, even more pref-erably 1:2 to 1:25, and most preferably 1:3 to 1:25.

In a preferred embodiment, in step (ii) the reaction of the polyalkyleneamine P and the lactone of formula (III) is carried out at 60 to 200° C., more preferably 80 to 200° C., more preferably 110 to 200° C., and most preferably at 140 to 200° C.

In a particularly preferred embodiment, in step (ii) the reaction of the polyalkyleneamine P and the lactone of formula (III) is carried at 170° C.

In a preferred embodiment, in step (iii) the weight ratio of polyalkyleneamine P and the lactone of formula (III) is in the range from 1:1 to 1:50.

In a preferred embodiment, in step (iii) the weight ratio of lactone of formula (III) and the acid is in the range from 1:5 to 5:1, and most preferably 1:5 to 1:1.

In a preferred embodiment, in step (iii) the reaction of the polyalkyleneamine P and the mix-ture comprising the lactone of formula (III) and the acid is carried out at 100 to 230° C.; more preferably 120 to 200° C.; and most preferably at 150 to 200° C.

In a preferred embodiment, in step (iv) the weight ratio of polyalkyleneamine P and the lac-tone of formula (III) is in the range from 1:1 to 1:50, and most preferably 1:1 to 1:25.

In a preferred embodiment, in step (iv) the weight ratio of lactone of formula (III) and the hydroxyacid is in the range from 1:10 to 5:1, and most preferably 1:10 to 2:1.

In a preferred embodiment, in step (iv) the reaction of the polyalkyleneamine P and the mix-ture comprising the lactone of formula (III) and the hydroxyacid is carried out at 100 to 230° C., more preferably 120 to 200° C., and most preferably at 150 to 200° C.

Optionally, step (iv) is carried out in the presence of a catalyst. In a preferred embodiment, the catalyst is titanium butoxide.

Another aspect of the presently claimed invention is directed to a coating composition comprising the silica dispersion of the presently claimed invention.

Another aspect of the presently claimed invention is directed to a UV curable coating compo-sition comprising the silica dispersion of the presently claimed invention.

Yet another aspect of the presently claimed invention is directed to use of the silica dispersion of the presently claimed invention as a coating agent.

Another aspect of the presently claimed invention is directed to a silica dispersion comprising
at least one silica,
at least one resin, and
at least one dispersant D comprising
   polyethyleneimine as a polymer backbone; and
   at least one polyoxyalkylenecarbonyl of formula (I) attached to polyeth-yleneimine by a C—N bond involving a nitrogen of polyethyleneimine and a carbonyl of A,

#-(A)ₘ-T (I)
wherein,
#indicates the point of attachment of (I) to a nitrogen atom of polyethyleneimine;
A is an oxyalkylenecarbonyl unit of formula —C(═O)—R¹—O—; and the polyoxy-alkylenecarbonyl (A)ₘ comprises identical or different oxyalkylenecarbonyl units and the polyoxyalkylenecarbonyl comprises identical or different oxyalkylenecar-bonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.

In a preferred embodiment, the silica dispersion comprises
at least one silica,
at least one resin, and
at least one dispersant D obtainable by step (i), (ii), (iii), or (iv);
(i) a process comprising reacting polyethyleneimine with at least one polyester (II) selected from II-A, II-B, and II-C,

HO-[A]ₘ—H (II-A),

HO-[A]ₘ—C(═O)R₂ (II-B), or

HO-[A]ₘ—C(═O)—R³—OH (II-C),
wherein R² and R³ are as defined above;
(ii) a process comprising reacting polyethyleneimine with at least one lactone of formula (III)

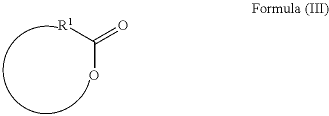

(iii) a process comprising reacting polyethyleneimine with a mixture comprising at least one lactone of formula (III) and at least one acid
   HO—C(═O)R², wherein R² is as defined above; and
(iv) a process comprising reacting polyethyleneimine with a mixture comprising at least one lactone of formula (III) and at least one hydroxyacid
   HO—C(═O)—R³—OH, wherein R³ is as defined above.

In a preferred embodiment, polyethyleneimine has a molecular weight in the range from 300 to 10000 g/mol determined to according to DIN 55672-1.

Another aspect of the presently claimed invention is directed to a method for preparing the silica dispersion comprising the following steps:
a. preparing at least one dispersant D by step (i), (ii), (iii), or (iv);
   i. a process comprising reacting polyethyleneimine with at least one pol-yester (II) selected from II-A, II-B, and II-C,

HO-[A]ₘ—H (II-A),

HO-[A]ₘ—C(═O)R₂ (II-B), or

HO-[A]ₘ—C(═O)—R³—OH (II-C),
wherein R² and R³ are as defined above;
ii. a process comprising reacting polyethyleneimine with at least one lac-tone of formula (III)

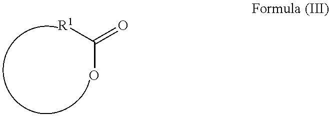

iii. a process comprising reacting polyethyleneimine with a mixture comprising at least one lactone of formula (III) and at least one acid
   HO—C(═O)R², wherein R² is as defined above; and
iv. a process comprising reacting polyethyleneimine with a mixture comprising at least one lactone of formula (III) and at least one hydroxyacid
   HO—C(═O)—R³—OH, wherein R³ is as defined above; and
b. mixing the dispersant D with at least one silica and at least one resin to obtain a homogeneous mixture.

The presently claimed invention offers one or more of the following advantages:
1. The presently claimed invention provides a silica dispersion having easy dispersibility.
2. The presently claimed invention provides a silica dispersion having good compatibility with variety of resins.
3. The presently claimed invention to provides a silica dispersion having a low viscosity and good Newtonian behavior.
4. A coating composition comprising the silica dispersion of the presently claimed inven-tion provides a coating with a good matting effect and a low gloss.

In the following, there are provided a list of embodiments to further illustrate the present dis-closure without intending to limit the disclosure to specific embodiments listed below.
1. A silica dispersion comprising
   at least one silica,
   at least one resin, and
   at least one dispersant D comprising
      a polyalkyleneamine P as a polymer backbone; and
      at least one polyoxyalkylenecarbonyl of formula (I) attached to the pol-yalkyleneamine P by a C—N bond involving a nitrogen of the polyalkyleneamine P and a carbonyl of A,

#-(A)ₘ-T (I)
wherein,
#indicates the point of attachment of (I) to a nitrogen atom of the polyalkylene-imine P;
A is an oxyalkylenecarbonyl unit of formula —C(═O)—R¹—O—; and the polyoxy-alkylenecarbonyl (A)ₘ comprises identical or different oxyalkylenecarbonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.
2. The silica dispersion according to embodiment 1 comprising
   at least one silica,
   at least one resin, and
   at least one dispersant D obtainable by step (i), (ii), (iii), or (iv);
(i) a process comprising reacting at least one polyalkyleneamine P with at least one polyester (II) selected from II-A, II-B, and II-C,

HO-[A]ₘ—H (II-A),

HO-[A]ₘ—C(═O)R₂ (II-B),

HO-[A]ₘ—C(═O)—R³—OH (II-C),
wherein R² and R³ are as defined above;
(ii) a process comprising reacting at least one polyalkyleneamine P with at least one lactone of formula (III)

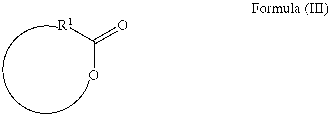

(iii) a process comprising reacting at least one polyalkyleneamine P with a mixture comprising at least one lactone of formula (III) and at least one acid
   HO—C(═O)R², wherein R² is as defined above; and
(iv) a process comprising reacting at least one polyalkyleamine P with a mixture comprising at least one lactone of formula (III) and at least one hydroxyacid
   HO—C(═O)—R³—OH, wherein R³ is as defined above.
3. The silica dispersion according to embodiment 1 or 2, wherein the polyalkyleneamine P is at least one selected from the group consisting of polyethyleneimine, and poly-propylenamine.
4. The silica dispersion according to any of embodiments 1 to 3, wherein polyalkyleneamine P is polyethyleneimine.
5. The silica dispersion according to any of embodiments 1 to 4, wherein polyalkyleneamine P has a molecular weight in the range from 300 to 10000 g/mol deter-mined to according to DIN 55672-1.
6. The silica dispersion according to any of embodiments 1 to 5, wherein polyalkyleneamine P has a molecular weight in the range from 500 to 2500 g/mol deter-mined to according to DIN 55672-1.
7. The silica dispersion according to any of embodiments 1 to 6, wherein R¹ is at least one selected from —(CH₂)₅—, —(CH₂)₄—, —(CH₂)₃—, and combinations thereof.
8. The silica dispersion according to any of embodiments 1 to 7, wherein (A)ₘ is

(A¹)_{M1}(A²)_{M2},
wherein A¹ and A² are different from each other and each is selected from the group consisting of —O—(CH₂)₅—C(═O)—, —O—(CH₂)₄—C(═O)— and —O—(CH₂)₃—C(═O)—; and
M1 and M2 are, identical or different, in the range from 1 to 40, and the ratio of M1 and M2 is in the range from 10:1 to 1:10.
9. The silica dispersion according to any of embodiments 1 to 8, wherein (A)ₘ is

—(—O—(CH₂)₅—C(═O)—)_{M1}(—O—(CH₂)₄—C(═O)—)_{M2},
wherein M1 and M2 are, identical or different, in the range from 1 to 40, and the ratio of M1 and M2 is in the range from 10:1 to 1:10.
10. The silica dispersion according to any of embodiments 1 to 9, wherein the dispersant D is

P-(A)ₘ—H (D-I)
11. The silica dispersion according to any of embodiments 1 to 9, wherein the dispersant D is

P-(A)ₘ—C(═O)R² (D-II)
wherein R² is a substituted or unsubstituted, linear or branched C₁₀-C₁₈ alkyl.
12. The silica dispersion according to embodiment 11, wherein R² is selected from C₁₁H₂₃, C₁₃H₂₇, C₁₅H₃₁, and C₁₇H₃₅.
13. The silica dispersion according to embodiment 11 or 12, wherein R² is C₁₁H23.
14. The silica dispersion according to any of embodiments 1 to 9, wherein the dispersant D is

P-(A)ₘ—C(═O)—R³—OH (D-III)
wherein R³ is a substituted or unsubstituted, linear or branched C₈-C₂₀ alkylene.
15. The silica dispersion according to any of embodiments 1 to 14, wherein R³ is selected from C₁₇H₃₄, 9, 10-dihydroxyoctadecyl, 2, 15, 16-trihydroxypalmityl, and 2, 15, 16-trihy-droxyhexadecyl.
16. The silica dispersion according to any of embodiments 1 to 15, wherein R³ is C₁₇H₃₄.
17. The silica dispersion according to any of embodiments 1 to 16, wherein the molecular weight of the dispersant D is in the range of 2,000 g/mol to 100,000 g/mol determined according to DIN 55672-1.
18. The silica dispersion according to any of embodiments 1 to 17, wherein the amine number of the dispersant D is in the range of 5 mg KOH/g to 200 mg KOH/g according to DIN 53176:2002-11.
19. The silica dispersion according to any of embodiments 1 to 18, wherein the acid num-ber of the dispersant D is in the range of 1 mg KOH/g to 50 mg KOH/g according to DIN 53402:1990-09.
20. The silica dispersion according to any of embodiments 1 to 19, wherein weight of the dispersant D is in the range of 0.1 to 10 wt. % based on the total weight of the silica dispersion.
21. The silica dispersion according to any of embodiments 1 to 20, wherein weight of the silica is in the range of 1 to 30 wt. % based on total weight of the silica dispersion.
22. The silica dispersion according to any of embodiments 1 to 21, wherein particle size (d₅₀) of the silica is in the range of 1 μm to 30 um according to DIN 66133.
23. The silica dispersion according to any of embodiments 1 to 22, wherein the silica is selected from amorphous silica and crystalline silica.
24. The silica dispersion according to any of embodiments 1 to 23, wherein the silica is organically treated silica.
25. The silica dispersion according to embodiment 24, wherein the silica is organically treated with at least one compound selected from wax.
26. The silica dispersion according to any of embodiments 1 to 25, wherein the resin is at least one selected from the group consisting of polyurethane resin, polyacrylate, pol-yether resin, epoxy resin, and polyester resin.
27. The silica dispersion according to any of embodiments 1 to 26, wherein the resin is a polyester resin.
28. The silica dispersion according to any of embodiments 1 to 27, wherein weight of the resin is in the range of 30 to 98 wt. % based on total weight of the silica dispersion.
29. The silica dispersion according to any of embodiments 1 to 28 further comprising at least one diluent.
30. The silica dispersion according to embodiment 29, wherein the diluent is a UV curable or radiation curable reactive diluent.
31. The silica dispersion according to embodiment 29 or 30, wherein the diluent is se-lected from the group consisting of dipropylene glycol di(meth)acrylate, 1,6-hexanediol di(meth)acrylate, trimethylolpropane tri(meth)acrylate, trimethylolpropane ethoxy tri(meth)acrylate, 2-phenoxyethyl (meth)acrylate, and glyceryl tetrapropylene tri(meth)acrylate.
32. The silica dispersion according to any of embodiments 29 to 31, wherein weight of the diluent is in the range of 0.1 wt. % to 50 wt. % based on total weight of the silica disper-sion.
33. The silica dispersion according to any of embodiments 1 to 32 further comprising at least one photoinitiator.
34. The silica dispersion according to embodiment 33, wherein the photoinitiator is 2-hy-droxy-2-methylpropiophenone.
35. The silica dispersion according to embodiment 33 or 34, wherein the weight of the photoinitiator is in the range of 0.1 wt. % to 10 wt. % based on the total weight of the silica dispersion.
36. The silica dispersion according to any of embodiments 1 to 35 having a dispersion viscosity in the range of 2500 to 10000 mPa·s.
37. The silica dispersion according to any of embodiments 1 to 36 having a Gloss 60° value in the range of 1 to 30.
38. The silica dispersion according to any of embodiments 1 to 37 further comprising at least one additive selected from wetting agent, defoaming agent, and levelling agent.
39. A method for preparing the silica dispersion of any of embodiments 1 to 38 comprising the following steps:
   a. preparing at least one dispersant D by step (i), (ii), (iii), or (iv);
      i. a process comprising reacting at least one polyalkyleneamine P with at least one polyester (II) selected from II-A, II-B, and II-C,

HO-[A]ₘ—H (II-A),

HO-[A]ₘ—C(═O)R₂ (II-B),

HO-[A]ₘ—C(═O)—R³—OH (II-C),
wherein R² and R³ are as defined above;
ii. a process comprising reacting at least one polyalkyleneamine P with at least one lactone of formula (III)

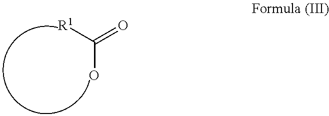

iii. a process comprising reacting at least one polyalkyleneamine P with a mixture comprising at least one lactone of formula (III) and at least one acid
   HO—C(═O)R², wherein R² is as defined above; and
iv. a process comprising reacting at least one polyalkyleamine P with a mixture comprising at least one lactone of formula (III) and at least one hydroxyacid
   HO—C(═O)—R³—OH, wherein R³ is as defined above; and
b. mixing the dispersant D with at least one silica and at least one resin to obtain a homogeneous mixture.
40. The method of embodiment 39, wherein in step (i) the weight ratio of polyalkyleneamine P and the polyester (II) is in the range from 1:1 to 1:50.
41. The method of embodiment 39 or 40, wherein in step (i) the reaction of the polyalkyleneamine P and the polyester (II) is carried out at 100 to 230° C.
42. The method of any of embodiments 39 to 41, wherein in step (ii) the weight ratio of polyalkyleneamine P and the lactone of formula (III) is in the range from 1:1 to 1:50.
43. The method of any of embodiments 39 to 42, wherein in step (ii) the reaction of the polyalkyleneamine P and the lactone of formula (III) is carried out at 60 to 200° C.
44. The method of any of embodiments 39 to 43, wherein in step (iii) the weight ratio of polyalkyleneamine P and the lactone of formula (III) is in the range from 1:1 to 1:50.
45. The method of any of embodiments 39 to 44, wherein in step (iii) the weight ratio of lactone of formula (III) and the acid is in the range from 1:5 to 5:1.
46. The method of any of embodiments 39 to 45, wherein in step (iii) the reaction of the polyalkyleneamine P and the mixture comprising the lactone of formula (III) and the acid is carried out at 100 to 230° C.
47. The method of any of embodiments 39 to 46, wherein in step (iv) the weight ratio of polyalkyleneamine P and the lactone of formula (III) is in the range from 1:1 to 1:50.
48. The method of any of embodiments 39 to 47, wherein in step (iv) the weight ratio of lactone of formula (III) and the hydroxyacid is in the range from 1:10 to 5:1.
49. The method of any of embodiments 39 to 48, wherein in step (iv) the reaction of the polyalkyleneamine P and the mixture comprising the lactone of formula (III) and the hydroxyacid is carried out at 100 to 230° C.
50. The method of any of embodiments 39 to 49, wherein step (a) is carried out in the presence of titanium butoxide as a catalyst.
51. A coating composition comprising the silica dispersion of any of embodiments 1 to 38.
52. A UV curable coating composition comprising the silica dispersion of any of embodi-ments 1 to 38.
53. Use of the silica dispersion of any of embodiments 1 to 38 as a coating agent.
54. A silica dispersion comprising
   at least one silica,
   at least one resin, and
   at least one dispersant D comprising
      polyethyleneimine as a polymer backbone; and
      at least one polyoxyalkylenecarbonyl of formula (I) attached to polyeth-yleneimine by a C—N bond involving a nitrogen of polyethyleneimine and a carbonyl of A,

#-(A)ₘ-T (I)
wherein,
#indicates the point of attachment of (I) to a nitrogen atom of polyethyleneimine;
A is an oxyalkylenecarbonyl unit of formula —C(═O)—R¹—O—; and the polyoxy-alkylenecarbonyl (A)ₘ comprises identical or different oxyalkylenecarbonyl units and the polyoxyalkylenecarbonyl comprises identical or different oxyalkylenecar-bonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.
55. The silica dispersion according to claim 54 comprising
   at least one silica,
   at least one resin, and
   at least one dispersant D obtainable by step (i), (ii), (iii), or (iv);
(i) a process comprising reacting polyethyleneimine with at least one polyester (II) selected from II-A, II-B, and II-C,

HO-[A]ₘ—H (II-A),

HO-[A]ₘ—C(═O)R₂ (II-B),

HO-[A]ₘ—C(═O)—R³—OH (II-C),
wherein R² and R³ are as defined above;
(ii) a process comprising reacting polyethyleneimine with at least one lactone of formula (III)

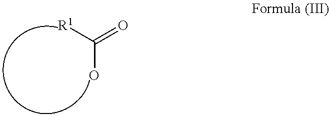

(iii) a process comprising reacting polyethyleneimine with a mixture comprising at least one lactone of formula (III) and at least one acid
   HO—C(═O)R², wherein R² is as defined above; and
(iv) a process comprising reacting polyethyleneimine with a mixture comprising at least one lactone of formula (III) and at least one hydroxyacid
   HO—C(═O)—R³—OH, wherein R³ is as defined above.
56. The silica dispersion according to claim 54 or 55, wherein polyethyleneimine has a molecular weight in the range from 300 to 10000 g/mol determined to according to DIN 55672-1.
57. A method for preparing the silica dispersion of any of claims 54 to 56 comprising the following steps:
   a. preparing at least one dispersant D by step (i), (ii), (iii), or (iv);
      i. a process comprising reacting polyethyleneimine with at least one pol-yester (II) selected from II-A, II-B, and II-C,

HO-[A]ₘ—H (II-A),

HO-[A]ₘ—C(═O)R₂ (II-B),

HO-[A]ₘ—C(═O)—R³—OH (II-C),
wherein R² and R³ are as defined above;
ii. a process comprising reacting polyethyleneimine with at least one lac-tone of formula (III)

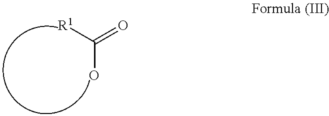

iii. a process comprising reacting polyethyleneimine with a mixture comprising at least one lactone of formula (III) and at least one acid
   HO—C(═O)R², wherein R² is as defined above; and
iv. a process comprising reacting polyethyleneimine with a mixture comprising at least one lactone of formula (III) and at least one hydroxy-acid
   HO—C(═O)—R³—OH, wherein R³ is as defined above; and
b. mixing the dispersant D with at least one silica and at least one resin to obtain a homogeneous mixture.

While the presently claimed invention has been described in terms of its specific embodiments, certain modifications and equivalents will be apparent to those skilled in the art and are intended to be included within the scope of the presently claimed invention.

### Examples

The presently claimed invention is illustrated in detail by non-restrictive working examples which follow. More particularly, the test methods specified hereinafter are part of the general disclosure of the application and are not restricted to the specific working examples.

### Materials

The following materials are used in the Examples:
CL: ε-caprolactone,
VL: δ-valerolactone,
PEI800: Lupasol®FG is a branched polyethylenimine polymer with the low molecular weight,
PEI2000: Lupasol®PR8515 is a water-free multi-functional cationic polyethyleneimine (PEI),
Laromer®UP35D is a medium reactive unsaturated polyester resin,
Laromer®DPGDA is a UV curable reactive diluent,
Efka®SI 2721 is a silicone-based defoamer, and
Darocure®1173 is a photoinitiator
were available from BASF Se.
LA: Lauric acid, and
12HSA: 12-hydroxyl stearic acid
were available from Sigma-Aldrich International GmbH.
PEI10k: Epomin™SP200 is the water-soluble polymer made by polymerization of ethylene-imine and is available from Nippon Shokubai.
Syloid®ED 50 is a high porosity, synthetic amorphous silica with particle size (d₅₀) of 7.6-9.2 um and is available from W.R. Grace.

### Methods

Molecular weight: The weight average molecular weight (Mw) was determined according to DIN 55672-1.
Amine number: The amine number was determined according to DIN 53176:2002-11.
Acid number: The acid number was determined according to DIN 53402:1990-09.
Gloss: Gloss 60° was determined according to DIN 67530 using a commercial reflectometer (Micro-Tri-Gloss reflectometer from BYK Gardner).
Viscosity: Viscosity was determined by analogy to DIN 53019-1:2008-09, using a Thermo-Haake RheoStress 600 equipment under the CR mode at 22° C. and a shear rate of 1 sec⁻¹ (Spindle CP50).
Newtonian flow property: The Newtonian flow property is determined by pseudoplasticity Index, i.e., the ratio of the viscosity at the shear rate of 100 s⁻¹ to the viscosity at the shear rate of 1 s⁻¹.

### A) Preparation of Polyester (Polyoxyalkylenecarbonyl)

### Example 1: Preparation of Intermediate A1

Lauric acid (20 g), caprolactam (50 g) and valerolactam (30 g) were mixed in a reactor. Tita-nium butoxide (0.5 g) was added to the mixture and resultant mixture was slowly heated to 170° C. The mixture was maintained at 170° C. until the solid content was greater than 97%. A liquid polyester was obtained with an acid number of 60 mgKOH/g.

### Example 2: Preparation of Intermediate A2

12-Hydroxyl stearic acid (20 g), caprolactam (50 g) and valerolactam (30 g) were mixed in a reactor. Titanium butoxide (0.5 g) was added to the mixture and the resultant mixture was slowly heated to 170° C. The mixture was maintained at 170° C. until the solid content was greater than 97%. A liquid polyester was obtained with an acid number of 40 mgKOH/g.

### Example 3: Preparation of Intermediate A3

12-Hydroxyl stearic acid (30 g) and caprolactam (70 g) were mixed in a reactor. Titanium butoxide (0.5 g) was added to the mixture and the resultant mixture was slowly heated to 170° C. The mixture was kept at 170° C. until the solid content was greater than 97%. A wax polyester was obtained with an acid number of 55 mgKOH/g.

### B) Preparation of Dispersant D

### Example 4: Preparation of Dispersant D1

PEI800 (10 g) and Intermediate A¹ (90 g) obtained from example 1 were mixed and the mix-ture was stirred at 170° C. under reduced pressure (approx. 20 mbar) until its acid number was 5 mg KOH/g. The obtained dispersant was a viscous yellowish liquid with an amine number of 45 mg KOH/g (GPC: Mw of 7500 g/mol, PDI of 2.7).

### Examples 5-7: Preparation of dispersants D2-D4

Dispersants D2-D4 were prepared by a process similar to the preparation of dispersant D1 (Example 4). The amounts and types of polyamines and polyesters used for preparation of dispersants D2-D4 and the properties of dispersants are provided in Table 1.

TABLE 1
Preparation of dispersants D2-D4

| | | | | | | Acid | Amine | | |
|---|---|---|---|---|---|---|---|---|---|
| | | Intermediate | | Polyethylene | | number | number | | |
| | | (polyester) | | Imine | | (mg | (mg | GPC | |
| Example | Dispersant | Type | Amount | Type | Amount | KOH/g) | KOH/g) | Mw | PDI |
| 5 | D2 | A2 | 95 g | PEI2000 | 5 g | 6 | 25 | 7850 | 2.5 |
| 6 | D3 | A2 | 80 g | PEI800 | 20 g | 6 | 90 | 5500 | 2.6 |
| 7 | D4 | A3 | 80 g | PEI800 | 20 g | 4 | 93 | 5250 | 2.4 |

### Example 8: Preparation of Dispersant D5

PEI800 (10 g), caprolactam (50 g) and valerolactam (20 g) were mixed and the mixture was stirred at 100° C. for 1h, followed by addition of 12-hydroxyl stearic acid (20 g) and titanium butoxide (0.5 g). The resultant mixture was stirred at 170° C. until solid content of the mixture was greater than 97%. The mixture was stirred at 170° C. under (approx. 20 mbar) until the acid number was 2 mg KOH/g. The obtained dispersant was a viscous yellowish liquid with an amine number of 43 mg KOH/g (GPC: Mw of 7250 g/mol, PDI of 2.3).

### Examples 9-15: Preparation of Dispersant D6-D12

Dispersant D6-D12 were prepared by a process similar to the preparation of dispersant D6 (Example 9). The amounts and types of polyamines and polyester raw materials used for preparation of dispersants D6-D12 and the properties of dispersants are provided in Table 2.

TABLE 2
Preparation of dispersants D6-D12

| | | Polyester raw | | | | | Acid | Amine | | |
|---|---|---|---|---|---|---|---|---|---|---|
| | | materials | | | Polyethylene | | number | number | | |
| | | | | hydroxy- | Imine | | (mg | (mg | GPC | |
| Ex. | Dispersant | CL | VL | acid | Type | Amount | KOH/g) | KOH/g) | Mw | PDI |
| 10 | D6 | 55 g | 20 g | 20 g | PEI800 | 5 g | 8 | 22 | 9850 | 2.5 |
| | | | | 12HSA | | | | | | |
| 11 | D7 | 55 g | 10 g | 15 g | PEI800 | 20 g | 2 | 85 | 6700 | 2.3 |
| | | | | 12HSA | | | | | | |
| 12 | D8 | 55 g | 0 | 25 g | PEI800 | 20 g | 5 | 88 | 6500 | 2.6 |
| | | | | 12HSA | | | | | | |
| 13 | D9 | 55 g | 15 g | 25 g | PEI800 | 10 g | 11 | 51 | 7450 | 2.7 |
| | | | | LA | | | | | | |
| 14 | D10 | 55 g | 20 g | 20 g | PEI2000 | 5 g | 5 | 25 | 10800 | 2.4 |
| | | | | 12HSA | | | | | | |
| 15 | D11 | 50 g | 20 g | 20 g | PEI2000 | 10 g | 4 | 43 | 9700 | 2.8 |
| | | | | LA | | | | | | |
| 16 | D12 | 45 g | 15 g | 20 g | PEI2000 | 20 g | 3 | 88 | 8550 | 2.5 |
| | | | | 12HSA | | | | | | |

*CL—ε-caprolactam,
VL—δ-valerolactam,
12HSA—12-Hydroxyl stearic acid,
LA—Lauric acid

### C) Silica Dispersion

Silica dispersions were prepared according to the following procedure. The amounts of com-ponents used for the preparation of the silica dispersions are provided in Table 3.

Laromer®UP35D and Laromer®DPGDA were added to a reactor and mixed. EKFARSI2721 and Darocure®1173 were added to the mixture followed by a dispersant from D1-D12 and the mixture was stirred with a Dispermat® until a homogeneous mixture formed. Solid Silica was slowly added to the homogeneous mixture under constant stirring and the resultant mixture was dispersed at high shear with Dispermat® at 3500 rpm for 10 min to obtain a silica disper-sion (silica matting agent).

TABLE 3
UV curable silica dispersion

| | | | |
|---|---|---|---|
| 1) | Laromer UP35D | 50 | g |
| 2) | Laromer DPGDA | 30 | g |
| 3) | Efka SI 2721 | 1 | g |
| 4) | Darocure 1173 | 4 | g |
| 5) | Dispersant D* | 1 | g |
| 6) | Silica: Syloid ED 50 | 14 | g |
| | Total | 100 | g |

*A dispersant from examples D1-D12

Properties of the silica dispersions (silica matting agents) obtained using dispersants D1-D12 was evaluated. The results are shown in Table 4.

The silica dispersions obtained using dispersants D1-D12 were applied on a black and white cardboard using a 12 um wirebar. The applied coating was immediately cured with UV radi-ation (energy, 10 m/min). The gloss 60° values of the coatings are shown in Table 4.

For comparison, a silica dispersion was prepared using the amounts mentioned in Table 3, except that the comparative silica dispersion did not contain a dispersant.

TABLE 4
properties of the Silica dispersion

| | | Dispersion viscosity | | | |
|---|---|---|---|---|---|
| | | (Viscosity @ 1 S⁻¹) | | | |
| | | m · Pas. | | | |
| | | | After 2 | Pseudo- | |
| Silica | | After 24 | weeks at | plasticity | Gloss |
| dispersion | Dispersant | h at RT | 50° C. | Index | 60° |
| Comparative | Without | 8550 | 11500 | 0.25 | 22 |
| example | dispersant | | | | |
| 1 | D1 | 3850 | 4050 | 0.30 | 13 |
| 2 | D2 | 4850 | 5000 | 0.45 | 15 |
| 3 | D3 | 3250 | 3300 | 0.35 | 13 |
| 4 | D4 | 2950 | 2900 | 0.30 | 14 |
| 5 | D5 | 3050 | 3050 | 0.60 | 15 |
| 6 | D6 | 3400 | 3450 | 0.45 | 14 |
| 7 | D7 | 2850 | 2800 | 0.40 | 12 |
| 8 | D8 | 2750 | 2850 | 0.45 | 10 |
| 9 | D9 | 2800 | 2750 | 0.55 | 11 |
| 10 | D10 | 4400 | 4600 | 0.40 | 12 |
| 11 | D11 | 3800 | 3950 | 0.35 | 11 |
| 12 | D12 | 3650 | 3800 | 0.45 | 10 |

* Pseudoplasticity Index is the ratio of the viscosity at the shear rate of 100 s⁻¹ to the viscosity at the shear rate of 1 s⁻¹.

It was observed that the performance of the dispersants D1-D12 was generally very good as indicated by a low millbase viscosity of silica dispersions 1-12 (Table 4). The silica dispersions 1-12 were found to have a good storage-stability as indicated by the dispersion viscosity values after 2 weeks at 50° C.

The silica dispersions of the presently claimed invention exhibited a good Newtonian flow property as indicated by high pseudoplasticity Index.

It was observed that the cured film showed a low gloss and a satisfactory matting effect (lower gloss meaning a better matting).

The comparative examples showed high dispersion viscosity, high gloss (low matting effect). Further, its dispersion viscosity increased significantly after 2 weeks indicating a low storage-stability.

1.-24. (canceled)

25. A silica dispersion comprising
at least one silica,
at least one resin, and
at least one dispersant D comprising
a polyalkyleneamine P as a polymer backbone; and
at least one polyoxyalkylenecarbonyl of formula (I) attached to the polyalkyleneamine P by a C—N bond involving a nitrogen of the polyalkyleneamine P and a carbonyl of A,
#-(A)ₘ-T (I)
wherein,
#indicates the point of attachment of (I) to a nitrogen atom of the polyalkyleneimine P;
A is an oxyalkylenecarbonyl unit of formula —C(═O)—R¹—O—; and the polyoxyalkylenecarbonyl (A)ₘ comprises identical or different oxyalkylenecarbonyl units and the polyoxyalkylenecarbonyl comprises identical or different oxyalkylenecarbonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.

26. The silica dispersion according to claim 25 comprising
at least one silica,
at least one resin, and
at least one dispersant D obtainable by step (i), (ii), (iii), or (iv);
(i) a process comprising reacting at least one polyalkyleneamine P with at least one polyester (II) selected from II-A, II-B, and II-C,
HO-[A]ₘ—H (II-A),
HO-[A]ₘ—C(═O)R₂ (II-B), or
HO-[A]ₘ—C(═O)—R³—OH (II-C),
wherein R² and R³ are as defined above;
(ii) a process comprising reacting at least one polyalkyleneamine P with at least one lactone of formula (III) 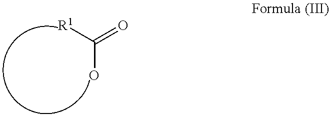
(iii) a process comprising reacting at least one polyalkyleneamine P with a mixture comprising at least one lactone of formula (III) and at least one acid
HO—C(═O)R², wherein R² is as defined above; and
(iv) a process comprising reacting at least one polyalkyleamine P with a mixture comprising at least one lactone of formula (III) and at least one hydroxyacid
HO—C(═O)—R³—OH, wherein R³ is as defined above.

27. The silica dispersion according to claim 25, wherein the polyalkyleneamine P is at least one selected from the group consisting of polyethyleneimine, and polypropylenamine.

28. The silica dispersion according to claim 25, wherein polyalkyleneamine P has a molecular weight in the range from 300 to 10000 g/mol determined to according to DIN 55672-1.

29. The silica dispersion according to claim 25, wherein R¹ is at least one selected from —(CH₂)₅—, —(CH₂)₄—, —(CH₂)₃—, and combinations thereof.

30. The silica dispersion according to claim 25, wherein (A)ₘ is
(A¹)_{M1}(A²)_{M2},
wherein A¹ and A² are different from each other and each is selected from the group consisting of —O—(CH₂)₅—C(═O)—, —O—(CH₂)₄—C(═O)— and —O—(CH₂)₃—C(═O)—; and
M1 and M2 are, identical or different, in the range from 1 to 40, and the ratio of M1 and M2 is in the range from 10:1 to 1:10.

31. The silica dispersion according to claim 25, wherein the molecular weight of the dispersant D is in the range of 2,000 g/mol to 100,000 g/mol determined according to DIN 55672-1.

32. The silica dispersion according to claim 25, wherein the amine number of the dispersant D is in the range of 5 mg KOH/g to 200 mg KOH/g according to DIN 53176:2002-11.

33. The silica dispersion according to claim 25, wherein the acid number of the dispersant D is in the range of 1 mg KOH/g to 50 mg KOH/g according to DIN 53402:1990-09.

34. The silica dispersion according to claim 25, wherein weight of the dispersant D is in the range of 0.1 to 10 wt. % based on the total weight of the silica dispersion.

35. The silica dispersion according to claim 25, wherein particle size (d₅₀) of the silica is in the range of 1 μm to 30 μm according to DIN 66133.

36. The silica dispersion according to claim 25, wherein the resin is at least one selected from the group consisting of polyurethane resin, polyether resin, epoxy resin, and polyester resin.

37. The silica dispersion according to claim 25 further comprising at least one diluent.

38. The silica dispersion according to claim 37, wherein the diluent is a UV curable or radiation curable reactive diluent.

39. The silica dispersion according to claim 25 further comprising at least one additive selected from wetting agent, defoaming agent, and levelling agent.

40. The silica dispersion according to claim 25 having a dispersion viscosity in the range of 2500 to 10000 mPa·s.

41. A method for preparing the silica dispersion of claim 25 comprising the following steps:
a. preparing at least one dispersant D by step (i), (ii), (iii), or (iv);
i. a process comprising reacting at least one polyalkyleneamine P with at least one polyester (II) selected from II-A, II-B, and II-C,
HO-[A]ₘ—H (II-A),
HO-[A]ₘ—C(═O)R² (II-B), or
HO-[A]ₘ—C(═O)—R³—OH (II-C),
wherein R₂ and R₃ are as defined above;
ii. a process comprising reacting at least one polyalkyleneamine P with at least one lactone of formula (III) 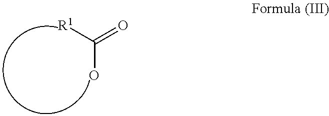
iii. a process comprising reacting at least one polyalkyleneamine P with a mixture comprising at least one lactone of formula (III) and at least one acid
HO—C(═O)R², wherein R² is as defined above; and
iv. a process comprising reacting at least one polyalkyleamine P with a mixture comprising at least one lactone of formula (III) and at least one hydroxyacid
HO—C(═O)—R³—OH, wherein R³ is as defined above; and
b. mixing the dispersant D with at least one silica and at least one resin to obtain a homogeneous mixture.

42. A coating composition comprising the silica dispersion of claim 25.

43. A UV curable coating composition comprising the silica dispersion of claim 25.

44. A method for coating a substrate comprising utilizing the silica dispersion of claim 25 as a coating agent.

45. A silica dispersion comprising
at least one silica,
at least one resin, and
at least one dispersant D comprising
polyethyleneimine as a polymer backbone; and
at least one polyoxyalkylenecarbonyl of formula (I) attached to polyethyleneimine by a C—N bond involving a nitrogen of polyethyleneimine and a carbonyl of A,
#-(A)m-T (I)
wherein,
#indicates the point of attachment of (I) to a nitrogen atom of polyethyleneimine;
A is an oxyalkylenecarbonyl unit of formula —C(═O)—R¹—O—; and the polyoxyalkylenecarbonyl (A)ₘ comprises identical or different oxyalkylenecarbonyl units and the polyoxyalkylenecarbonyl comprises identical or different oxyalkylenecarbonyl units;
m is in the range of 3 to 50; and
T is at least one selected from H, —C(═O)—R², and —C(═O)—R³—OH;
wherein,
R¹ is a substituted or unsubstituted, linear or branched C₃-C₈ alkylene;
R² is a substituted or unsubstituted, linear or branched C₁₀-C₁₈ alkyl; and
R³ is a substituted or unsubstituted, linear or branched C₈-C₂₀ alkylene.

46. The silica dispersion according to claim 45 comprising
at least one silica,
at least one resin, and
at least one dispersant D obtainable by step (i), (ii), (iii), or (iv);
(i) a process comprising reacting polyethyleneimine with at least one polyester (II) selected from II-A, II-B, and II-C,
HO-[A]ₘ—H (II-A),
HO-[A]ₘ—C(═O)R₂(II-B), or
HO-[A]ₘ—C(═O)—R³—OH (II-C),
wherein R² and R³ are as defined above;
(ii) a process comprising reacting polyethyleneimine with at least one lactone of formula (III) 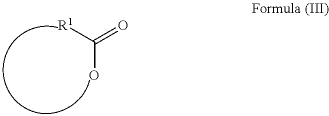
(iii) a process comprising reacting polyethyleneimine with a mixture comprising at least one lactone of formula (III) and at least one acid
HO—C(═O)R², wherein R² is as defined above; and
(iv) a process comprising reacting polyethyleneimine with a mixture comprising at least one lactone of formula (III) and at least one hydroxyacid
HO—C(═O)—R³—OH, wherein R³ is as defined above.

47. The silica dispersion according to claim 45, wherein polyethyleneimine has a molecular weight in the range from 300 to 10000 g/mol determined to according to DIN 55672-1.

48. A method for preparing the silica dispersion of claim 45 comprising the following steps:
a. preparing at least one dispersant D by step (i), (ii), (iii), or (iv);
i. a process comprising reacting polyethyleneimine with at least one polyester (II) selected from II-A, II-B, and II-C,
HO-[A]ₘ—H (II-A),
HO-[A]ₘ—C(═O)R² (II-B), or
HO-[A]ₘ—C(═O)—R³—OH (II-C),
wherein R² and R³ are as defined above;
ii. a process comprising reacting polyethyleneimine with at least one lactone of formula (III) 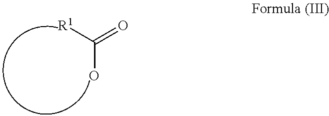
iii. a process comprising reacting polyethyleneimine with a mixture comprising at least one lactone of formula (III) and at least one acid
HO—C(═O)R², wherein R² is as defined above; and
iv. a process comprising reacting polyethyleneimine with a mixture comprising at least one lactone of formula (III) and at least one hydroxyacid
HO—C(═O)—R³—OH, wherein R³ is as defined above; and
b. mixing the dispersant D with at least one silica and at least one resin to obtain a homogeneous mixture.
